(19) United States
(12) Patent Application Publication
(10) Pub. No.: US 2012/0030558 A1
(43) Pub. Date: Feb. 2, 2012

(54) Electronic Book and Method for Displaying Annotation Thereof

(75) Inventors: Chih-Liang Chiu, Taipei (TW); Yung-Chang Liang, Taipei (TW); Tzu-Fang Su, Taipei (TW)

(73) Assignee: PEGATRON CORPORATION, Taipei (TW)

(21) Appl. No.: 13/189,671

(22) Filed: Jul. 25, 2011

(30) Foreign Application Priority Data
Jul. 29, 2010 (TW) 099125072

(51) Int. Cl. G06F 17/20

(52) U.S. Cl. 715/233

(57) ABSTRACT

This disclosure provides an electronic book and a method for displaying an annotation used for displaying an annotation image at an electronic book. The annotation image is located at an annotation position of an electronic book document and is capable of being displayed on a screen of the electronic book when the electronic book document is displayed in a pre-set font size. The method includes the following steps. When the electronic book document is displayed in another font size and the annotation position is within a current displaying range of the screen, an annotation reminder is displayed; the electronic book document is displayed in the pre-set font size and the annotation image is displayed at the annotation position as well according to an annotation activating signal.

### CROSS-REFERENCE TO RELATED APPLICATIONS

This Non-provisional application claims priority under 35 U.S.C. §119(a) on Patent Application No(s). 099125072 filed in Taiwan, Republic of China on Jul. 29, 2010, the entire contents of which are hereby incorporated by reference.

### BACKGROUND

1. Technical Field

This disclosure relates to an electronic book and, more particularly, to an electronic book and a method for displaying an annotation thereof.

2. Description of the Related Art

Electronic books have been the main stream of current information carriers due to the tendency and the onset of an Internet age. Many websites provide abundant and free electronic book resources including general books, research reports, theses, conference proceedings, government publication and so on. Further, many websites also provide charged service of downloading electronic books besides the free electronic book resources. Therefore, when a user is to read a certain electronic book, it is very convenient to download the electronic book into an electronic book apparatus and thus operates the electronic book apparatus for reading.

When the user is reading the conventional paper books, he or she can annotate directly on pages by a pen. For the electronic book, the annotation is achieved by storing an annotation image annotated via a touch or other mode by the user. FIG. 1A and FIG. 1B are schematic diagrams according to a conventional art. In FIG. 1A, an annotation image 500 annotated in an electronic book 800 is substantially an independent file and is displayed over an original page 10. However, in FIG. 1B, if the user adjusts the size of the font, the annotation image 500 may fail to be displayed since the position of the annotation image 500 on the adjusted page 20 may not be adjusted correspondingly.

### SUMMARY

One embodiment of the invention is to provide an electronic book and a method for displaying an annotation thereof used for displaying an annotation image at an electronic book, thus improving convenience of reading the electronic book.

In a method for displaying an annotation according to the embodiment, the annotation image is located at an annotation position of an electronic book document and is capable of being displayed on a screen of the electronic book when the electronic book document is displayed in a pre-set font size. The method for displaying an annotation includes the following steps. An annotation reminder is displayed when the electronic book document is displayed in another font size and the annotation position is within a current displaying range of the screen. The electronic book document is displayed in the pre-set font size and the annotation image is displayed at the annotation position according to an annotation activating signal.

The embodiment of the invention further provides an electronic book using the aforementioned method for displaying an annotation image. In one embodiment, the electronic book includes a screen, a memory, and a processor. The screen is used for displaying at least one portion of the electronic book document. The memory has a plurality of instructions used for executing the aforementioned method for displaying an annotation image; the processor is used for executing the instructions.

These and other features, aspects, and advantages of the present invention will become better understood with regard to the following description, appended claims, and accompanying drawings.

### BRIEF DESCRIPTION OF THE DRAWINGS

FIG. 1A and FIG. 1B are schematic diagrams according to a conventional art;

FIG. 2 is a flow chart according to one preferred embodiment of the invention;

FIG. 3A and FIG. 3B are schematic diagrams according to one preferred embodiment of the invention; and

FIG. 4 is a schematic diagram of an electronic book according to one preferred embodiment of the invention.

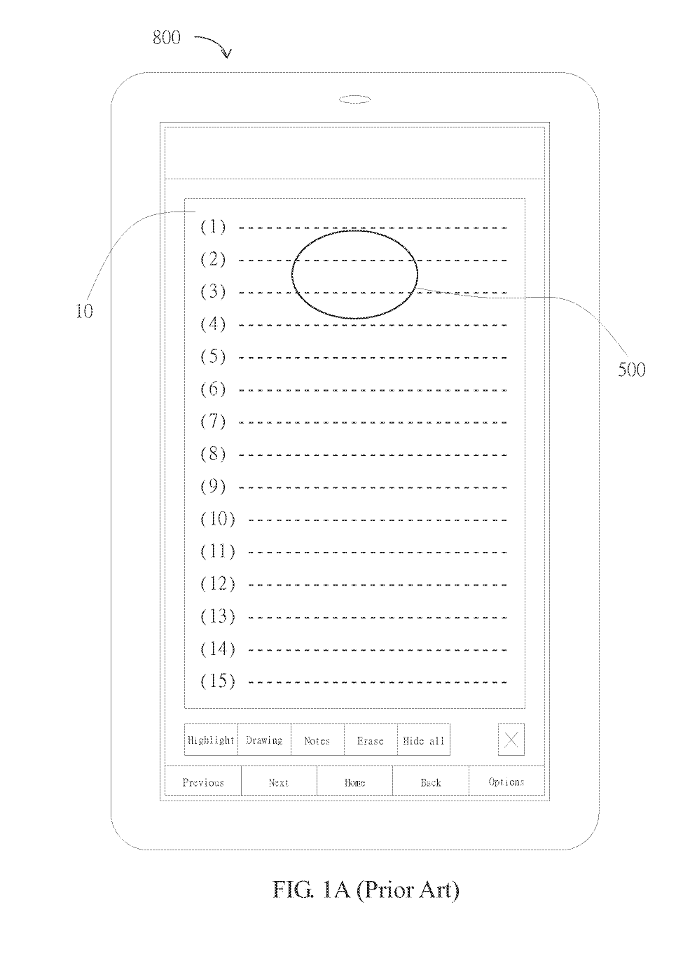

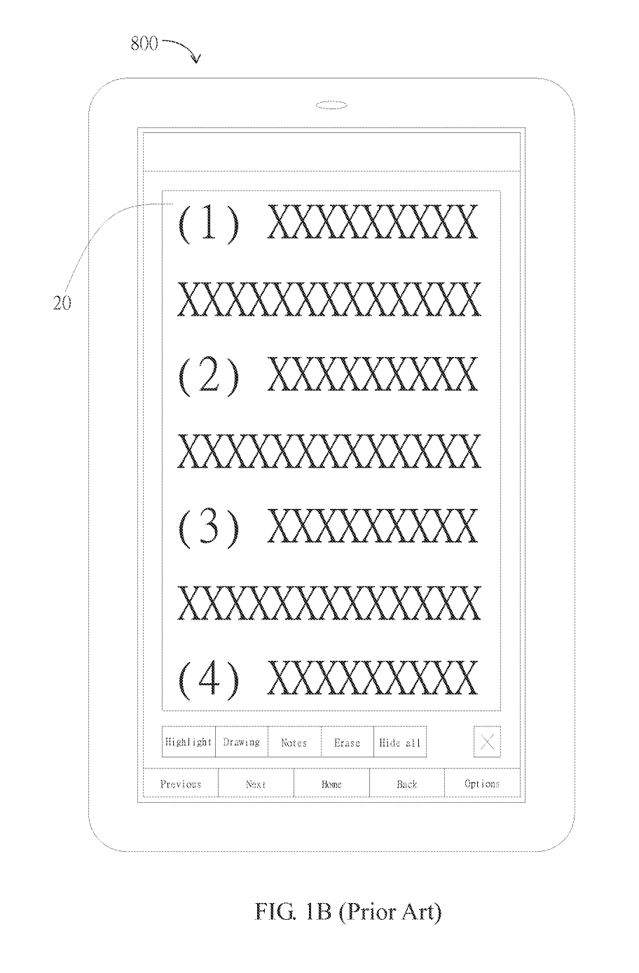

### DETAILED DESCRIPTION OF THE INVENTION

The embodiment of the invention provides an electronic book and a method for displaying an annotation thereof preferably used for displaying an annotation image at an electronic book. However, in different embodiments, the method may also be used in other electronic devices having the same or similar functions of browsing electronic documents with the electronic book, such as mobile phones, mobile internet devices, personal digital assistants, digital frames, digital walkmans, electronic dictionaries, global positioning system navigation devices, notebook computers, and tablet personal computers.

In one embodiment of the invention, an annotation image is located at an annotation position of an electronic book document and is displayed on a screen of the electronic book when the electronic book document is displayed in a pre-set font size. Further, when the electronic book document is displayed in the pre-set font size, the annotation image is allowed to be annotated at the electronic book. The electronic book document has a great deal of pagination information arranged according to the pre-set font size. The pre-set font size may be designated or pre-determined by a user of the electronic book. For example, the electronic book document can be paginated in a minimum font size first, and then the pagination information can be stored.

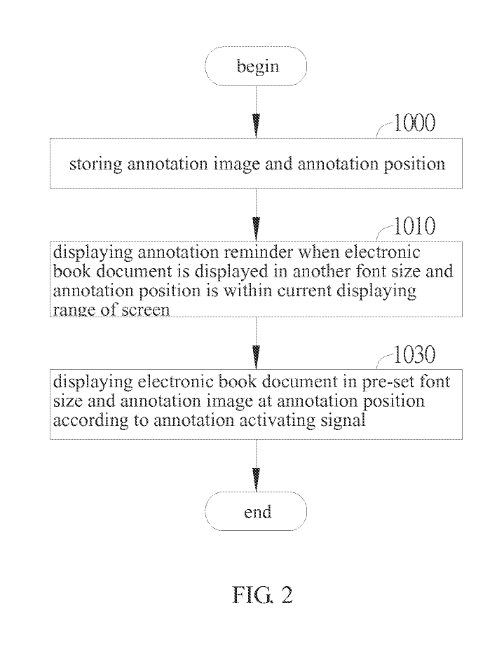

FIG. 2 is a flow chart according to one preferred embodiment of the invention. In FIG. 2, the method for displaying an annotation in the embodiment includes the following steps.

In step 1000, an annotation image and an annotation position are stored. That is, the electronic book stores image files generated due to the annotation by the user and the corresponding annotation position, thus allowing the image files to be displayed when the user browses this page next time. When the annotation image is annotated at the electronic book, the electronic book document is displayed in the pre-set font size. When the electronic book stores the annotation image and the annotation position, an annotation reminder is preferably generated and stored simultaneously. The annotation position may be pagination information or character information of the annotated portion. In other words, the annotation reminder and the annotation image can correspond to the same annotation position such as the pagination information or the character information.

In step 1010, when the electronic book document is displayed in another font size and the annotation position is within a current displaying range of the screen, the annotation reminder is displayed. The another font size in which the electronic book document is displayed when the user reads the electronic book document is different from the pre-set font size. When the annotation position corresponding to the annotation image is within the current displaying range of the screen, the screen displays the annotation reminder. This means that there is an annotation image at this page.

The another font size may be different as reading habits or organ functions of the users. For example, for users used to reading many characters simultaneously, they may prefer small font sizes thus allowing more characters to be displayed per unit area of the electronic book. For users having poor sight, they may prefer large font sizes thus reducing eye loads when reading. The adjusting of the preferred font size can be achieved by directly selecting the font size such as selecting the corresponding font size in a font size menu. However, in different embodiments, it can also be achieved by adjusting a display scale of the electronic book.

In step 1030, the electronic book document is displayed in the pre-set font size and the annotation image is displayed at the annotation position according to an annotation activating signal. The annotation activating signal is preferably triggered via selecting the annotation reminder by the user of the electronic book. That is, the annotation reminder is selected to trigger the annotation activating signal. Further, the annotation activating signal can also be triggered via selecting an annotation editing mode. When the electronic book displays the electronic book document in the pre-set font size and the annotation image as well, the annotation image is displayed over the annotation position of the electronic book document and is displayed on the screen since the pre-set font size is used when the annotation image is annotated.

As described above, the pre-set font size can be designated or pre-determined by the user of the electronic book. In the embodiment, the step of defining the pre-set font size is included. The user can designate the pre-set font size in the system settings of the electronic book to re-define the pre-set font size.

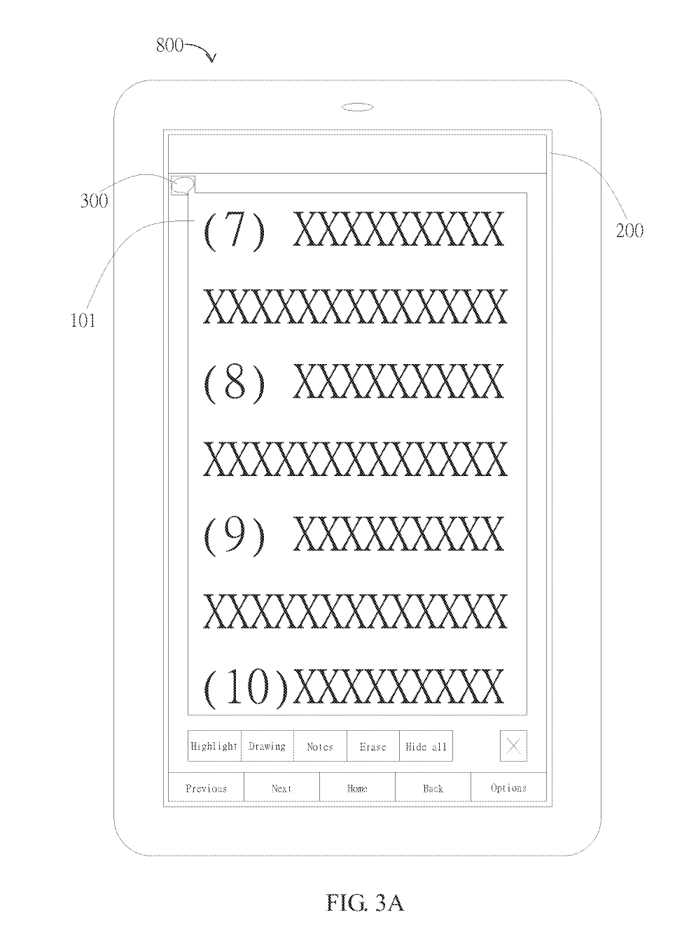

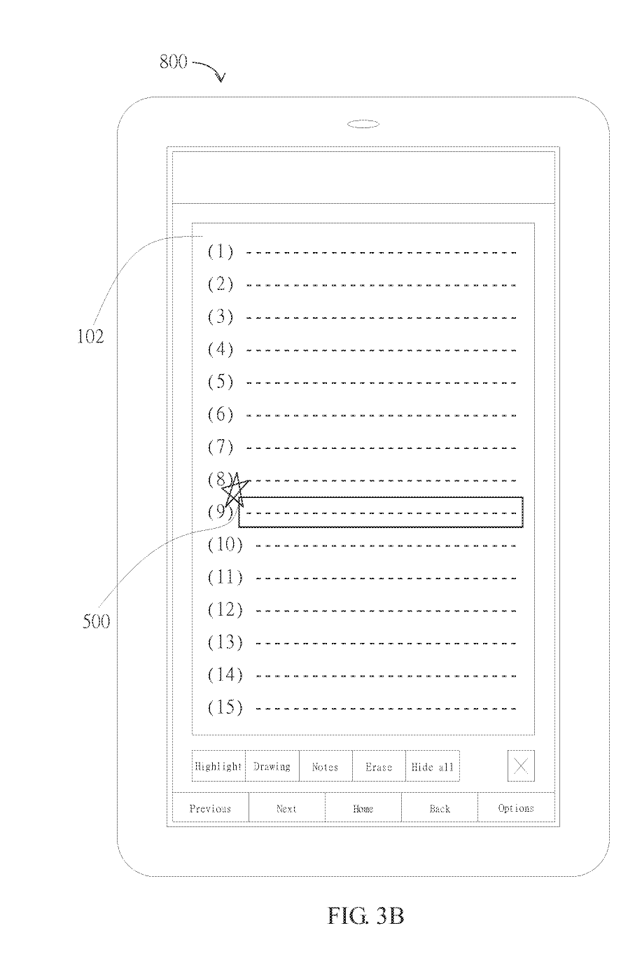

FIG. 3A and FIG. 3B are schematic diagrams according to one preferred embodiment of the invention. In FIG. 3A, an electronic book 800 includes a screen 200 for displaying an annotation reminder 300. The electronic book 800 displays a first page 101 of an electronic book document in another font size. The screen 200 may include a touch screen. When the user selects the annotation reminder 300 in FIG. 3A via a click or cursor, an annotation activating signal can be triggered, thus allowing the electronic book 800 to display the electronic book document in the pre-set font size and to display the annotation image 500 at an annotation position as shown in FIG. 3B. The annotation image 500 is annotated on the screen 200 of the electronic book via a figure, a stylus, or cursor by the user. When the annotation image 500 is displayed, it can be edited. The editing includes highlighting, drawing, taking notes, or erasing. In different embodiments, the annotation activating signal can also be triggered via selecting an annotation editing mode by the user of the electronic book. In other words, when the user is to annotate or edit the annotation image 500 at the electronic book, he or she can select the annotation editing mode thus to trigger the annotation activating signal, allowing the electronic book 800 to display the electronic book document in the pre-set font size and to display the annotation image at the annotation position for facilitating annotation or editing of the annotation image 500 by the user.

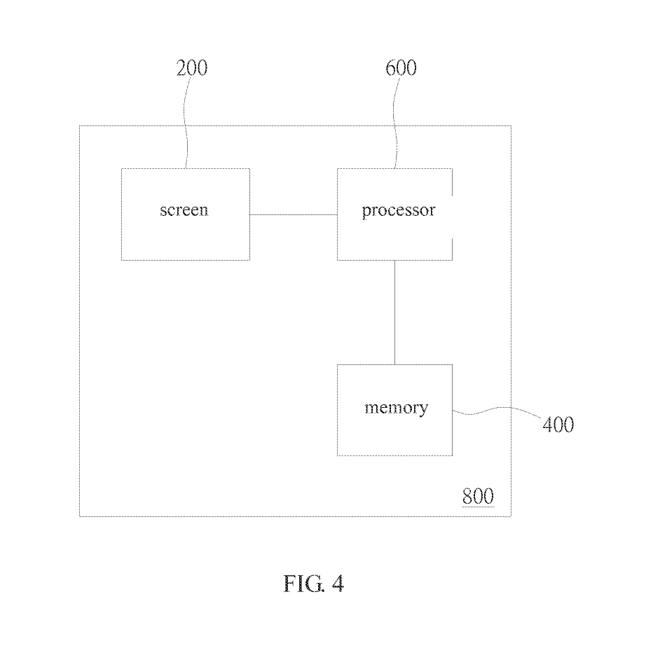

FIG. 4 is a schematic diagram of an electronic book according to one preferred embodiment of the invention. An electronic book 800 in the embodiment includes a screen 200, a memory 400, and a processor 600. The screen 200 is used for displaying at least one portion of the electronic book document; the memory 400 has a plurality of instructions; the processor 600 is used for executing the instructions.

To sum up, according to the method for displaying an annotation, when the user browses the page having the annotation reminder 300 representing the annotation image in a preferred font size, he or she can select the annotation reminder 300 via touch or cursor, thus allowing the electronic book 800 to display the page in the pre-set font size and to display the annotation image on the page as well. Accordingly, the situation that the annotation image is not displayed when the user reads the electronic book document in other font sizes can be avoided, thus improving the convenience of reading the electronic book.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for displaying an annotation, used for displaying an annotation image at an electronic book, the annotation image located at an annotation position of an electronic book document, the annotation image capable of being displayed on a screen of the electronic book when the electronic book document is displayed in a pre-set font size, the method comprising the following steps of:
displaying an annotation reminder when the electronic book document is displayed in another font size and the annotation position is within a current displaying range of the screen; and
displaying the electronic book document in the pre-set font size and the annotation image at the annotation position according to an annotation activating signal.

2. The method for displaying an annotation according to claim 1, further comprising the step of allowing the annotation image to be annotated at the electronic book when the electronic book document is displayed in the pre-set font size.

3. The method for displaying an annotation according to claim 1, wherein the electronic book document has a great deal of pagination information arranged according to the pre-set font size.

4. The method for displaying an annotation according to claim 1, further comprising the step of allowing the annotation image to be annotated at the electronic book and storing the annotation image and the annotation position when the electronic book document is displayed in the pre-set font size.

5. The method for displaying an annotation according to claim 1, further comprising the step of allowing the annotation image to be edited.

6. The method for displaying an annotation according to claim 5, wherein the editing of the annotation image comprises highlighting, drawing, taking noting, or erasing.

7. The method for displaying an annotation according to claim 1, further comprising the step of triggering the annotation activating signal via selecting the annotation reminder.

8. The method for displaying an annotation according to claim 1, further comprising the step of triggering the annotation activating signal via selecting an annotation editing mode.

9. The method for displaying an annotation according to claim 1, further comprising the step of defining the pre-set font size.

10. An electronic book for displaying an annotation image, the annotation image located at an annotation position of an electronic book document and displayed when the electronic book document is displayed in a pre-set font size, the electronic book comprising:
a screen for displaying at least one portion of the electronic book document;
a memory having a plurality of instructions, the instructions used for executing the following steps of:
displaying an annotation reminder on the screen when the electronic book document is displayed in another font size and the annotation position is within a current displaying range of the screen;
displaying the electronic book document in the pre-set font size and the annotation image at the annotation position on the screen according to an annotation activating signal; and
a processor for executing the instructions.

11. The electronic book according to claim 10, wherein the screen comprises a touch screen.

12. The electronic book according to claim 11, wherein the annotation activating signal is triggered via clicking the annotation reminder by a user of the electronic book.
